(19) United States
(12) Patent Application Publication
(10) Pub. No.: US 2025/0308744 A1
(43) Pub. Date: Oct. 2, 2025

(54) COIL COMPONENT

(71) Applicant: TDK Corporation, Tokyo (JP)

(72) Inventors: Kyosuke INUI, Tokyo (JP); Koji SHIMURA, Tokyo (JP); Hirofumi SASAKI, Tokyo (JP); Hitoshi SASAKI, Tokyo (JP); Masashi GOTOH, Tokyo (JP); Naoto TSUKAMOTO, Tokyo (JP); Toru KADOI, Tokyo (JP); Sena YOSHINO, Tokyo (JP)

(73) Assignee: TDK Corporation, Tokyo (JP)

(21) Appl. No.: 19/086,655

(22) Filed: Mar. 21, 2025

(30) Foreign Application Priority Data
Mar. 29, 2024 (JP) 2024-057822

(51) Int. Cl. H01F 27/02; H01F 27/255; H01F 27/28; H01F 27/29

(52) U.S. Cl. CPC H01F 27/022; H01F 27/255; H01F 27/2828; H01F 27/292

(57) ABSTRACT

An exterior body contains magnetic particles having different average particle sizes and a resin. The exterior body includes a body portion covering at least a core portion and a winding portion, and a covering portion raised with respect to an outer end surface of the flange portion, and overlapping the outer end surface when viewed in an axial direction. In a cross-section of the exterior body, an area ratio of the magnetic particles having a small average particle size is higher in the covering portion than in the body portion.

This application claims priority to Japanese patent application No. 2024-057822 filed on Mar. 29, 2024 which is incorporated herein by reference in its entirety.

### BACKGROUND

The present disclosure relates to a coil component.

Patent Document 1 discloses a technique related to a surface-mount coil component that can be used as, for example, an inductor. The coil component of Patent Document 1 includes a core, a coil, and an exterior body. The core includes a core portion on which the coil is provided, and a flange portion formed at one end of the core portion in an axial direction. The exterior body covers at least the core portion and the coil. In the coil component of Patent Document 1, a part of the exterior body covers an outer end surface of the flange portion (a surface opposite to an inner end surface (a surface to which the core portion is connected) of the flange portion). Therefore, the malfunction of the core coming out of the exterior body can be prevented.
Patent Document 1: JP 2017-510072 A

### SUMMARY

In order to effectively prevent the malfunction of the core coming out of the exterior body, there is a demand for a technique to further increase the fixing strength between the core and the exterior body.

The present disclosure provides a coil component capable of increasing the fixing strength between a core and an exterior body.

A coil component according to one embodiment of the present disclosure includes a core including a core portion and a flange portion formed at one end of the core portion in an axial direction; a wire including a winding portion provided on the core portion; and an exterior body containing magnetic particles having different average particle sizes and a resin. The exterior body includes a body portion covering at least the core portion and the winding portion, and a covering portion raised with respect to an outer end surface of the flange portion, and overlapping the outer end surface when viewed in the axial direction. In a cross-section of the exterior body, an area ratio of the magnetic particles having a small average particle size is higher in the covering portion than in the body portion.

In the coil component according to one embodiment of the present disclosure, the exterior body includes the body portion covering at least the core portion and the winding portion, and the covering portion raised with respect to the outer end surface of the flange portion, and overlapping the outer end surface when viewed in the axial direction of the core portion. Since the covering portion covers the outer end surface of the flange portion, the covering portion serves as a stopper (retainer) that fixes the core to the body portion. Accordingly, the fixing strength (connection strength) between the core and the exterior body is increased, so that the core is less likely to peel off from the exterior body.

In addition, in the coil component according to one embodiment of the present disclosure, in a cross-section of the exterior body, the area ratio of the magnetic particles having a small average particle size is higher in the covering portion than in the body portion. Therefore, the magnetic particles of the covering portion easily enter irregularities formed on the outer end surface of the flange portion, and the covering portion is fixed (connected) to the flange portion via the magnetic particles that have entered the irregularities. Accordingly, the fixing strength (connection strength) between the flange portion and the covering portion is increased, so that the core is even less likely to peel off from the exterior body.

The exterior body may include a peripheral edge portion raised with respect to the outer end surface of the flange portion, and not overlapping the outer end surface when viewed in the axial direction. In a cross-section of the exterior body, an area ratio of the magnetic particles having a small average particle size may be higher in the covering portion than in the peripheral edge portion.

The flange portion may include an inner end surface facing the outer end surface along the axial direction, a side surface connecting the inner end surface and the outer end surface, and a chamfered portion formed at a ridge portion between the outer end surface and the side surface.

The covering portion may have a small particle size region and a large particle size region. The small particle size region may not overlap the chamfered portion when viewed in the axial direction. The large particle size region may overlap the chamfered portion when viewed in the axial direction. An area ratio of the magnetic particles having a large average particle size may be higher in the large particle size region than in the small particle size region.

The small particle size region may be located closer to an inside of the outer end surface than the large particle size region in a radial direction of the flange portion.

The core may be a sintered core having voids.

The covering portion may contain the magnetic particles having an average particle size that can enter the voids.

A surface roughness of the outer end surface may be smaller than a surface roughness of the covering portion.

The coil component may further include a first terminal electrode and a second terminal electrode provided at least on the outer end surface. The wire may include a first lead-out portion led out from the winding portion and connected to the first terminal electrode, and a second lead-out portion led out from the winding portion and connected to the second terminal electrode. The covering portion may be located at least in an inter-electrode region between the first terminal electrode and the second terminal electrode.

### BRIEF DESCRIPTION OF THE DRAWINGS

FIG. 1 is a perspective view of one example of a coil component of a first embodiment;

FIG. 2 is a perspective view illustrating an internal configuration of the coil component of FIG. 1;

FIG. 3 is a perspective view of a core and a wire illustrated in FIG. 2;

FIG. 4 is a perspective view of the coil component illustrated in FIG. 1 when viewed from a mounting surface side;

FIG. 5 is a cross-sectional view of the coil component illustrated in FIG. 2 taken along line V-V;

FIG. 6 is a cross-sectional view of the coil component illustrated in FIG. 2 taken along line VI-VI;

FIG. 7 is a partially enlarged cross-sectional view of the coil component illustrated in FIG. 6;

FIG. 8 is a cross-sectional view of a coil component of a second embodiment;

FIG. 9 is a cross-sectional view of the coil component illustrated in FIG. 8 when viewed in an X-axis direction;

FIG. 10 is a plan view of a modification example of the coil component illustrated in FIG. 4;

FIG. 11 is a plan view of a modification example of the coil component illustrated in FIG. 4;

FIG. 12 is a cross-sectional view of a modification example of the coil component illustrated in FIG. 5; and

FIG. 13 is a perspective view of a modification example of the coil component illustrated in FIG. 4.

### DETAILED DESCRIPTION

Hereinafter, embodiments of the present disclosure will be described with reference to the drawings. The illustrated contents are provided schematically and exemplarily merely for the understanding of the present disclosure, and the appearance, dimensional ratio, or the like can be different from the actual product. In addition, the present disclosure is not limited to the following embodiments.

### First Embodiment

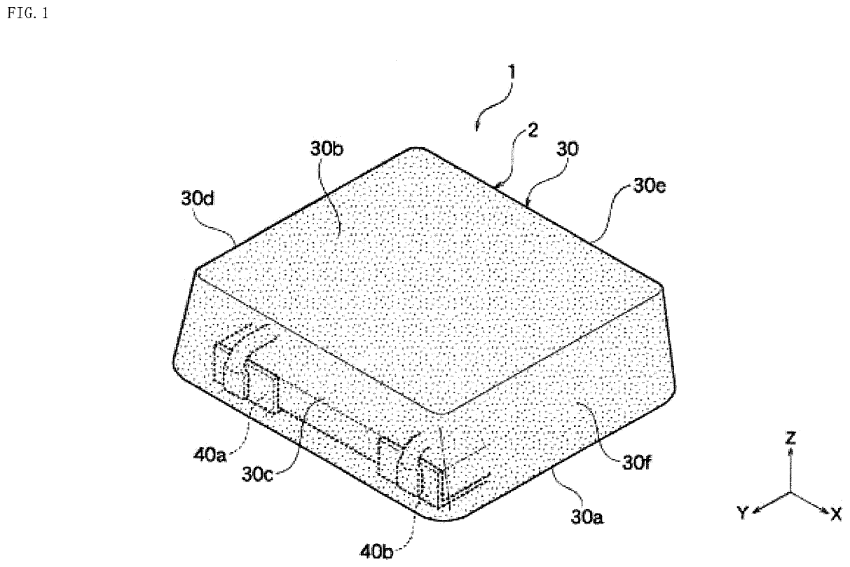

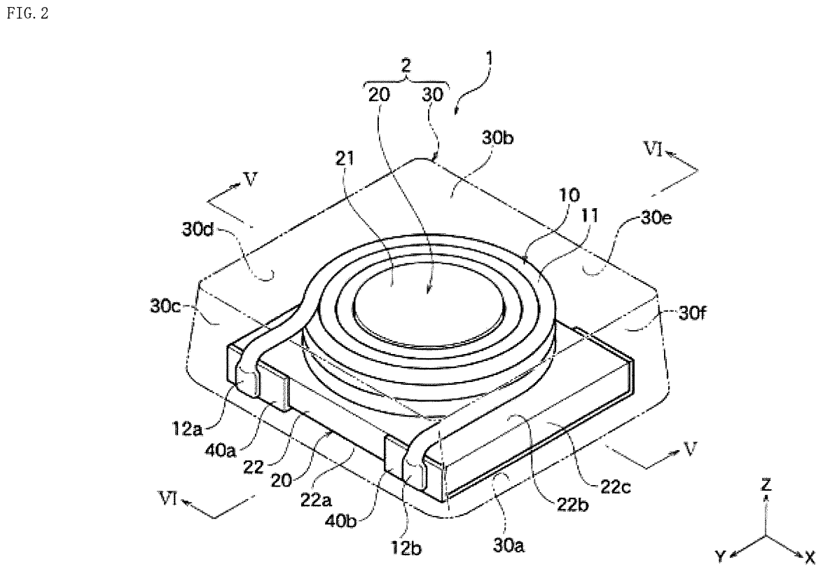

A coil component 1 of a first embodiment illustrated in FIG. 1 functions as, for example, an inductor, and is mounted in power supplies and the like of various electrical devices. As illustrated in FIG. 2, the coil component 1 includes an element body 2, a wire 10, and terminal electrodes 40a and 40b. The coil component 1 is a surface-mount coil component.

The element body 2 includes a core 20 and an exterior body 30. The element body 2 is a hexahedron, but may be another polyhedron such as an octahedron. The element body 2 has a first surface 30a on which the terminal electrodes 40a and 40b are disposed; a second surface 30b facing the first surface 30a; and one or more connecting surfaces that connect the first surface 30a and the second surface 30b. In the present embodiment, the element body 2 is a hexahedron. Therefore, the element body 2 has a third surface 30c; a fourth surface 30d adjacent to the third surface 30c; a fifth surface 30e adjacent to the fourth surface 30d; and a sixth surface 30f adjacent to the fifth surface 30e, as the connecting surfaces that connect the first surface 30a and the second surface 30b.

In FIG. 2 and the like, an X-axis is an axis corresponding to a direction in which the fourth surface 30d and the sixth surface 30f face each other. A Y-axis is an axis corresponding to a direction in which the third surface 30c and the fifth surface 30e face each other. A Z-axis is an axis corresponding to a direction in which the first surface 30a and the second surface 30b face each other. The X-axis, the Y-axis, and the Z-axis are perpendicular to each other. Hereinafter, for each of the X-axis, the Y-axis, and the Z-axis, a direction away from the center of the element body 2 is defined as the outside, and a direction toward the center of the element body 2 is defined as the inside. In addition, the positive direction side of the Z-axis is defined as an upper side (upward), and the negative direction side of the Z-axis is defined as a lower side (downward). However, the upper side in a Z-axis direction does not necessarily coincide with an upper side in a vertical direction. In addition, the lower side in the Z-axis direction does not necessarily coincide with a lower side in the vertical direction.

In the present disclosure, “equal”, “same”, “equivalent”, or “similar” does not only refer to a concept indicating a state where the physical quantities of a plurality of objects being compared are strictly equal, the same, equivalent, or similar, but the concept of “equal”, “same”, “equivalent”, or “similar” also includes a state where an error of ±Δ% (although not particularly limited, for example, Δ=7, 5, or 3) or less occurs between the physical quantities of the plurality of objects being compared.

In addition, in the present disclosure, “parallel” does not only refer to the concept of being strictly parallel, but the concept of “parallel” also includes a state where an error of ±Δθ° (although not particularly limited, for example, Δθ=3) or less occurs with respect to being strictly parallel. In addition, “perpendicular” or “orthogonal” does not only refer to the concept of being strictly perpendicular or orthogonal, but also the concept of “perpendicular” or “orthogonal” also includes a state where an error of ±Δθ° (although not particularly limited, for example, Δθ=3) or less occurs with respect to being strictly perpendicular or orthogonal.

A length of the element body 2 in an X-axis direction is not particularly limited, but is, for example, 0.6 to 6.5 mm. A length of the element body 2 in a Y-axis direction is not particularly limited, but is, for example, 0.6 to 6.5 mm. A length of the element body 2 in the Z-axis direction is not particularly limited, but is, for example, 0.5 to 5.0 mm.

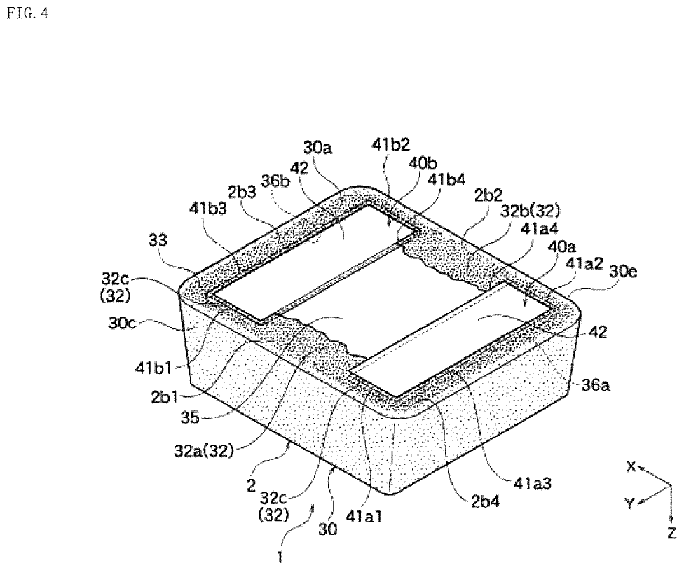

As illustrated in FIG. 1, the second surface 30b, the third surface 30c, the fourth surface 30d, the fifth surface 30e, and the sixth surface 30f are formed by the exterior body 30. Meanwhile, as illustrated in FIG. 4, the first surface 30a is formed by an outer end surface 22a of the core 20 and a part of the exterior body 30 located around the outer end surface 22a, and constitutes a mounting surface of the element body 2. The mounting surface is a surface that faces a mounting substrate (not illustrated) when the coil component 1 is mounted on the mounting substrate.

The element body 2 is not limited to a polyhedron, and may be a columnar body such as a circular pole from the viewpoint of effective magnetic flux. In the present disclosure, examples of the columnar body also include a solid body in which the first surface 30a and the second surface 30b are not congruent, such as a truncated cone. When the element body 2 has a circular pole shape or a truncated cone shape, the element body 2 is provided with one connecting surface that connects the first surface 30a and the second surface 30b.

The element body 2 is molded, for example, by pouring an exterior material constituting the exterior body 30 into a cavity of a press mold in which the core 20 is installed, and compressing and hardening the exterior material. The exterior material (exterior body 30) is made of a composite material containing magnetic particles (magnetic fillers) and a resin. Particularly, in the present embodiment, the exterior material contains magnetic particles (magnetic powder) having different average particle sizes. The molding of the element body 2 can also be performed by resin molding, transfer molding, injection molding, dry molding, or the like.

A particle size of the magnetic particles constituting the exterior material is not particularly limited, but is, for example, 0.5 μm to 50 μm. The magnetic material (magnetic filler) constituting the exterior material is not particularly limited, but is, for example, ferrite, a metallic magnetic material, or the like Examples of the metallic magnetic material include, although not particularly limited, soft magnetic metallic magnetic materials such as sendust (Fe—Si—Al: iron-silicon-aluminum), Fe—Si—Cr (iron-silicon-chromium), Fe—C—Si, Fe—Cr—Al, permalloy (Fe—Ni), Fe—Ni—Al, Fe—Ni—Mo, carbonyl iron, carbonyl Ni, amorphous powder, and nanocrystal powder. Examples of ferrite include Mn—Zn and Ni—Cu—Zn. The resin constituting the exterior material is not particularly limited, but is, for example, an epoxy resin, a phenol resin, an acrylic resin, a polyester resin, polyimide, polyamideimide, a silicone resin, or a combination thereof. A relative magnetic permeability of the exterior body 30 is not particularly limited, but is, for example, 1 to 20000.

As illustrated in FIG. 1, the third surface 30c, the fourth surface 30d, the fifth surface 30e, and the sixth surface 30f are inclined surfaces that form acute angles with respect to the first surface 30a. However, the third surface 30c, the fourth surface 30d, the fifth surface 30e, and the sixth surface 30f may be orthogonal to the first surface 30a.

Curved portions are formed at a ridge portion between the third surface 30c and the fourth surface 30d, a ridge portion between the fourth surface 30d and the fifth surface 30e, a ridge portion between the fifth surface 30e and the sixth surface 30f, and a ridge portion between the sixth surface 30f and the third surface 30c. The curved portions are curved in a cross-section perpendicular to a direction orthogonal to the first surface 30a (Z-axis direction). These curved portions are not essential and may be omitted.

As illustrated in FIG. 2, the core 20 includes a core portion 21 and a flange portion 22. The core 20 is a T-core, and is configured as a sintered body (sintered core). The core 20 (the core portion 21 and/or the flange portion 22) has voids. The core 20 may be formed from a composite material containing a magnetic material and a resin. In addition, the core 20 may be formed, for example, by powder compression molding, injection molding, machining, or the like. The material (magnetic material and/or resin) constituting the core 20 may be the same as or different from the material constituting the exterior body 30. A relative magnetic permeability of the core 20 may be the same as or different from the relative magnetic permeability of the exterior body 30. For example, the core 20 may be made of a material having a higher relative magnetic permeability than the exterior body 30.

The core portion 21 has a circular pole shape, and protrudes from a center portion of the flange portion 22. An axial direction of the core portion 21 corresponds to the Z-axis direction. In addition, the axial direction of the core portion 21 corresponds to a winding axis direction of a winding portion 11. The core portion 21 may protrude at a position offset from the center portion of the flange portion 22 in a radial direction thereof. The core portion 21 is located inside the exterior body 30. The shape of the core portion 21 may be, for example, a quadratic pole, an octagonal pole, or another polygonal pole.

The flange portion 22 has a flat rectangular parallelepiped shape (flat plate shape), and is formed at one end of the core portion 21 in the axial direction. The flange portion 22 has an outer end surface 22a, an inner end surface 22b, and a side surface 22c. The inner end surface 22b is a surface connected to the core portion 21. The outer end surface 22a is a surface facing the inner end surface 22b. The side surface 22c is a surface that connects the outer end surface 22a and the inner end surface 22b. The flange portion 22 is disposed parallel to the second surface 30b of the exterior body 30. The shape of the flange portion 22 in a plan view may be, for example, a circular shape, an octagonal shape, or another polygonal shape.

As illustrated in FIG. 4, the outer end surface 22a of the flange portion 22 is partially exposed at the first surface 30a. The terminal electrode 40a is provided on one side of the outer end surface 22a in the X-axis direction, and the terminal electrode 40b is provided on the other side of the outer end surface 22a in the X-axis direction. As indicated by dashed lines in FIG. 4, the flange portion 22 includes an electrode contact portion 36a located on the one side of the outer end surface 22a in the X-axis direction, and an electrode contact portion 36b located on the other side of the outer end surface 22a in the X-axis direction. The electrode contact portion 36a is a contact surface between the terminal electrode 40a and the outer end surface 22a, and the terminal electrode 40a is in contact with the electrode contact portion 36a. The electrode contact portion 36b is a contact surface between the terminal electrode 40b and the outer end surface 22a, and the terminal electrode 40b is in contact with the electrode contact portion 36b.

A thermal expansion coefficient of the core 20 (at least one of the flange portion 22 and the core portion 21) may be equal to a thermal expansion coefficient of the exterior body 30, or may be different from the thermal expansion coefficient of the exterior body 30. The thermal expansion coefficient of the core 20 (at least one of the flange portion 22 and the core portion 21) may be smaller than the thermal expansion coefficient of the exterior body 30, or may be larger than the thermal expansion coefficient of the exterior body 30.

When the core portion 21 is formed from an annealed metal, the thermal expansion coefficient of the core portion 21 is, for example, 10 ppm/K or more and 20 ppm/K or less. When the core portion 21 is formed from a composite material containing a magnetic material and a resin, the thermal expansion coefficient of the core portion 21 is, for example, 20 ppm/K or more and 60 ppm/K or less. The thermal expansion coefficient of the exterior body 30 is, for example, 15 ppm/K. A difference between the thermal expansion coefficient of the core portion 21 and the thermal expansion coefficient of the exterior body 30 may be, for example, 2 ppm/K or more, or may be 5 ppm/K or more. The difference between the thermal expansion coefficient of the core portion 21 and the thermal expansion coefficient of the exterior body 30 may be, for example, 45 ppm/K or less, or may be 10 ppm/K or less. In this case, cracks can be prevented from occurring in the exterior body 30 around the core portion 21 due to the thermal expansion coefficient of the core portion 21.

As an example of a method for making the thermal expansion coefficient of the core portion 21 smaller than the thermal expansion coefficient of the exterior body 30, a method for performing annealing treatment on the core portion 21 is provided When the core portion 21 contains magnetic particles and a resin, the content ratio of the resin can be reduced by performing annealing treatment on the core portion 21, so that the thermal expansion coefficient of the core portion 21 can be reduced.

In addition, the thermal expansion coefficient of the core portion 21 may be made smaller than the thermal expansion coefficient of the exterior body 30 by forming the core 20 from a material different from that of the exterior body 30. Alternatively, when both the core 20 and the exterior body 30 contain magnetic particles and a resin, the thermal expansion coefficient of the core portion 21 may be made smaller than the thermal expansion coefficient of the exterior body 30 by making the compound ratio of the resin in the core 20 smaller than the compound ratio of the resin in the exterior body 30. Alternatively, the thermal expansion coefficient of core portion 21 may be made smaller than the thermal expansion coefficient of exterior body 30 by making the core 20 (the core portion 21 and/or the flange portion 22) from ceramics such as sintered ferrite.

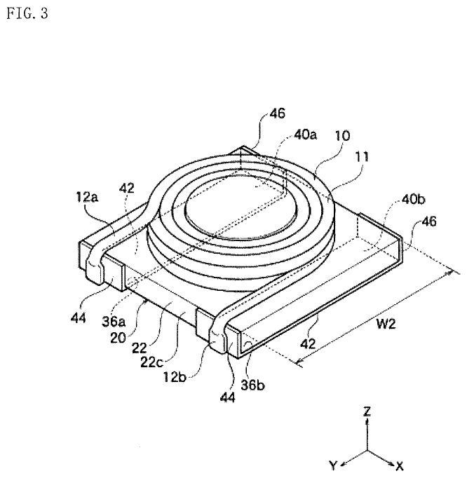

As illustrated in FIG. 2, the wire 10 includes the winding portion 11 wound in a coil shape, and lead-out portions 12a and 12b led out from the winding portion 11. The winding portion 11 is located inside the exterior body 30, and is provided on an outer peripheral surface of the core portion 21. The winding portion 11 is formed, for example, by winding a wire around the core portion 21. However, when the winding portion 11 is a coreless coil, the winding portion 11 may be fitted into the core portion 21. As the wire forming the winding portion 11, for example, a conductive core wire such as a flat wire, a round wire, a stranded wire, a Litz wire, or a braided wire made of copper or the like, or an insulation-covered wire in which such a conductive core wire is covered with an insulating coating can be used. Specifically, known winding wires such as AIW, UEW, PEW, and USTC can be used. A diameter of the wire is not particularly limited, but is, for example, 50 μm to 2 mm when the wire is a round wire. When the wire is a flat wire, for example, a thickness of the wire is 20 μm to 2 mm, and a width of the wire is 40 μm to 2 mm. As illustrated in FIG. 3, the number of layers of the winding portion 11 in the winding axis direction is, for example, three, and the number of layers in the radial direction is, for example, three.

As illustrated in FIG. 2, the lead-out portions 12a and 12b are led out from the winding portion 11, and constitute one end and the other end of the wire forming the winding portion 11. The lead-out portion 12a is led out from one end of the winding portion 11 in the Z-axis direction toward the third surface 30c of the exterior body 30 inside the exterior body 30. The lead-out portion 12b is led out from the other end of the winding portion 11 in the Z-axis direction toward the third surface 30c of the exterior body 30 inside the exterior body 30.

As illustrated in FIG. 3, the terminal electrodes 40a and 40b are formed on the flange portion 22, and are spaced apart from each other along the X-axis. Each of the terminal electrodes 40a and 40b includes an exposed portion 42 and embedded portions 44 and 46. The exposed portion 42 is disposed on the outer end surface 22a, and extends along the Y-axis. The shape of the exposed portion 42 is not particularly limited, but is, for example, a rectangular shape in a plan view. At least a part of the exposed portion 42 is exposed from the first surface 30a (refer to FIG. 4). The embedded portions 44 and 46 are disposed on the side surface 22c, and face each other along the Y-axis. The embedded portion 44 extends upward from one end of the exposed portion 42 in a longitudinal direction. The embedded portion 46 extends upward from the other end of the exposed portion 42 in the longitudinal direction.

The lead-out portion 12a is connected to the terminal electrode 40a, and the lead-out portion 12b is connected to the terminal electrode 40b. The lead-out portion 12a is connected to the embedded portion 44 of the terminal electrode 40a. The lead-out portion 12b is connected to the embedded portion 44 of the terminal electrode 40b. Each of the terminal electrodes 40a and 40b is formed as, for example, a laminated electrode film including a base electrode film and a plating film formed on the foundation electrode film. The base electrode film is not particularly limited, but may be, for example, a conductive paste film containing a metal such as Sn, Ag, Ni, Cu, or Pd, or an alloy thereof. The plating film is not particularly limited, but may be made of, for example, a metal such as Sn, Au, Ni, Pt, Ag, Pd, or Cu, or an alloy thereof.

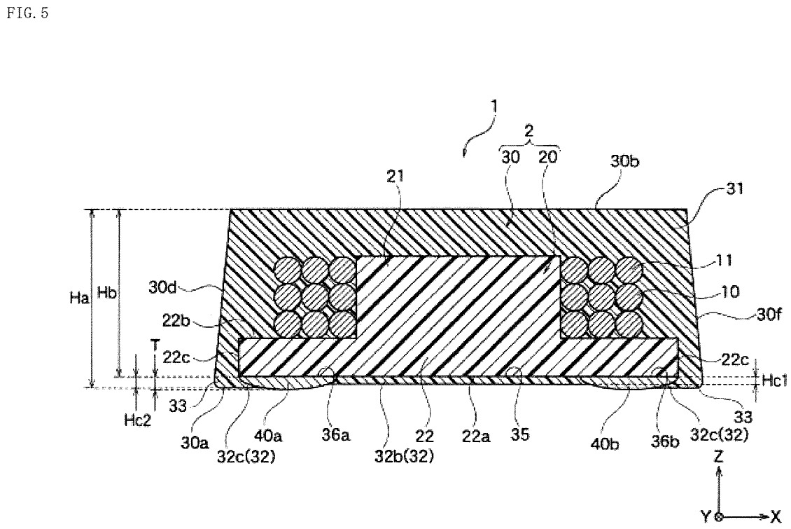

As illustrated in FIG. 5, the thickness of the terminal electrode 40a in a cross-section becomes thinner toward an outer edge portion of the terminal electrode 40a, and becomes thicker toward the center of the terminal electrode 40a. The cross-sectional shape of the terminal electrode 40a is a convex shape protruding downward. The similar configuration is applied to the cross-sectional shape of the terminal electrode 40b. However, the cross-sectional shape of the terminal electrodes 40a and 40b is not limited to the shape illustrated in FIG. 5. For example, the cross-sectional shape of the terminal electrodes 40a and 40b may be a rectangular shape.

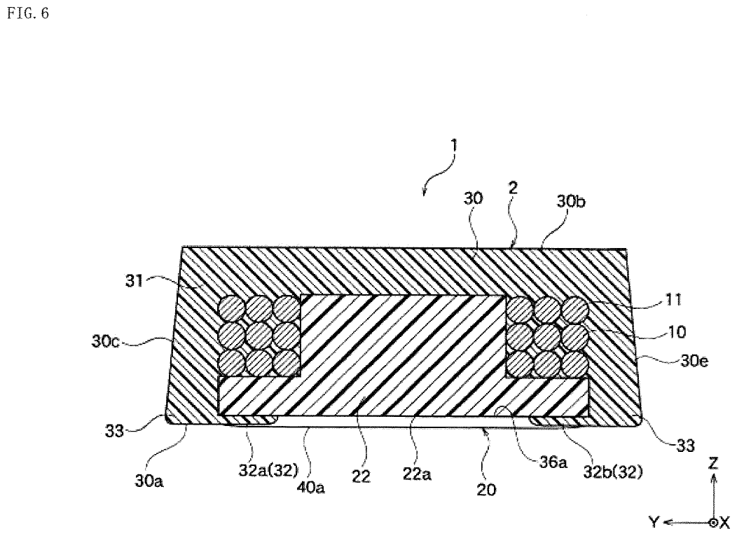

As illustrated in FIG. 6, the thickness of the terminal electrode 40a in a longitudinal section becomes thinner toward the outer edge portion of the terminal electrode 40a, and becomes thicker toward the center of the terminal electrode 40a. The longitudinal sectional shape of the terminal electrode 40a is a convex shape protruding downward. The similar configuration is applied to the longitudinal sectional shape of the terminal electrode 40b. However, the longitudinal sectional shape of the terminal electrodes 40a and 40b is not limited to the shape illustrated in FIG. 6. For example, the longitudinal sectional shape of the terminal electrodes 40a and 40b may be a rectangular shape.

As illustrated in FIG. 5, a thickness T of each of the terminal electrodes 40a and 40b is, for example, 3 μm to 100 μm. The thickness of the terminal electrode 40a is equal to the thickness of the terminal electrode 40b, but may be different. The lead-out portion 12a is connected to the terminal electrode 40a, for example, by thermocompression bonding, solder connection, or a conductive adhesive. The lead-out portion 12b is connected to the terminal electrode 40b, for example, by thermocompression bonding, solder connection, or a conductive adhesive.

As illustrated in FIG. 4, an outer periphery of the exposed portion 42 of the terminal electrode 40a has a first side 41a1, a second side 41a2, a third side 41a3, and a fourth side 41a4. The first side 41al and the second side 41a2 extend parallel to each other along the X-axis, but may extend non-parallel to each other. The third side 41a3 and the fourth side 41a4 extend parallel to each other along the Y-axis, but may extend non-parallel to each other.

An outer periphery of the exposed portion 42 of the terminal electrode 40b has a first side 41b1, a second side 41b2, a third side 41b3, and a fourth side 41b4. The first side 41b1 and the second side 41b2 extend parallel to each other along the X-axis, but may extend non-parallel to each other. The third side 41b3 and the fourth side 41b4 extend parallel to each other along the Y-axis, but may extend non-parallel to each other.

The first side 41a1, the second side 41a2, and the third side 41a3 are located on an outer edge portion of the first surface 30a. In addition, the first side 41b1, the second side 41b2, and the third side 41b3 are located on the outer edge portion of the first surface 30a. Here, the outer edge portion of the first surface 30a includes an outer periphery of the first surface 30a and a peripheral portion of the outer periphery of the first surface 30a. The peripheral portion of the outer periphery of the first surface 30a is a region between a first position on the outer periphery of the first surface 30a and a second position spaced apart a predetermined length inward from the first position in the X-axis direction or the Y-axis direction (however, in the radial direction when the shape of the first surface 30a is a circular shape, an elliptical shape, or the like). Here, inward refers to a direction toward the center of the first surface 30a. In addition, the predetermined length is, for example, a length equivalent to 30% or less of the length of the first surface 30a in the X-axis direction or the Y-axis direction (however, a diameter, a major axis, or a minor axis when the shape of the first surface 30a is a circular shape, an elliptical shape, or the like).

The outer edge portion of the first surface 30a includes a first outer edge portion 2b1, a second outer edge portion 2b2, a third outer edge portion 2b3, and a fourth outer edge portion 2b4. The first outer edge portion 2b1 and the second outer edge portion 2b2 extend parallel to each other along the X-axis, but may extend non-parallel to each other. The third outer edge portion 2b3 and the fourth outer edge portion 2b4 extend parallel to each other along the Y-axis, but may extend non-parallel to each other.

As illustrated in FIG. 5, the exterior body 30 includes a body portion 31, a covering portion 32, and a peripheral edge portion 33. The body portion 31 covers at least the core portion 21 and the winding portion 11. In addition, the body portion 31 covers at least a part of the flange portion 22 (the inner end surface 22b and the side surface 22c). A surface roughness of the outer end surface 22a of the flange portion 22 is larger than a surface roughness of the covering portion 32. However, the surface roughness of the outer end surface 22a may be smaller than the surface roughness of the covering portion 32, or may be equal to the surface roughness of the covering portion 32.

Both the covering portion 32 and the peripheral edge portion 33 are raised (protrude) with respect to the outer end surface 22a of the flange portion 22. The covering portion 32 overlaps the outer end surface 22a of the flange portion 22 when viewed in the axial direction of the core portion 21 (namely, the Z-axis direction). The covering portion 32 includes a covering portion 32a, a covering portion 32b, and a covering portion 32c. As illustrated in FIG. 4, the covering portions 32a and 32b are formed in an inter-electrode region 35 between the terminal electrode 40a and the terminal electrode 40b.

The covering portion 32a is located on one side (third surface 30c side) of the inter-electrode region 35 in the Y-axis direction, and projects inward from the outer edge portion of the first surface 30a in the Y-axis direction. In addition, the covering portion 32b is located on the other side (fifth surface 30e side) of the inter-electrode region 35 in the Y-axis direction, and projects inward from the outer edge portion of the first surface 30a in the Y-axis direction. The covering portions 32a and 32b are disposed to face each other along the Y-axis.

In addition, the covering portion 32a physically connects the terminal electrode 40a and the terminal electrode 40b on the one side of the inter-electrode region 35 in the Y-axis direction so as to bridge a space between the terminal electrode 40a and the terminal electrode 40b in the X-axis direction. In addition, the covering portion 32b physically connects the terminal electrode 40a and the terminal electrode 40b on the other side of the inter-electrode region 35 in the Y-axis direction so as to bridge the space between the terminal electrode 40a and the terminal electrode 40b in the X-axis direction.

The covering portion 32c is a portion of the covering portion 32 excluding the covering portions 32a and 32b, namely, a portion not located in the inter-electrode region 35. As illustrated in FIG. 5, the covering portion 32c overlaps, for example, the outer edge portion of the terminal electrode 40a on the one side in the X-axis direction. In addition, the covering portion 32c overlaps, for example, an outer edge portion of the terminal electrode 40b on the other side in the X-axis direction. The covering portion 32c overlaps the first side 41a1, the second side 41a2, and the third side 41a3 of the terminal electrode 40a illustrated in FIG. 4. In addition, the covering portion 32c overlaps the first side 41b1, the second side 41b2, and the third side 41b3 of the terminal electrode 40b.

As illustrated in FIG. 5, the covering portion 32b (similarly for the covering portion 32a) is raised with respect to the electrode contact portion 36a and the electrode contact portion 36b. Particularly, the covering portion 32b is raised with respect to an outer edge portion (particularly, a portion along the inter-electrode region 35) of the electrode contact portion 36a. In addition, the covering portion 32b is raised with respect to an outer edge portion (particularly, a portion along the inter-electrode region 35) of the electrode contact portion 36b.

Here, the outer edge portion of the electrode contact portion 36a includes an outer periphery of the electrode contact portion 36a and a peripheral portion of the outer periphery of the electrode contact portion 36a. The peripheral portion of the outer periphery of the electrode contact portion 36a is a region between a first position on the outer periphery of the electrode contact portion 36a and a second position spaced apart a predetermined length inward from the first position in the X-axis direction or the Y-axis direction (however, in the radial direction when the shape of the electrode contact portion 36a is a circular shape, an elliptical shape, or the like). The predetermined length is, for example, a length equivalent to 30% or less of the length of the electrode contact portion 36a in the X-axis direction or the Y-axis direction (however, a diameter, a major axis, or a minor axis when the shape of the electrode contact portion 36a is a circular shape, an elliptical shape, or the like). An outer edge portion of the electrode contact portion 36b is defined in a manner similar to that of the outer edge portion of the electrode contact portion 36a.

The covering portion 32b (similarly for the covering portion 32a) is located lower than an average height position of the electrode contact portion 36a. Particularly, the covering portion 32b is located lower than an average height position of the outer edge portion (particularly, the portion along the inter-electrode region 35) of the electrode contact portion 36a. In addition, the covering portion 32b is located lower than an average height position of the electrode contact portion 36b. Particularly, the covering portion 32b is located lower than an average height position of the outer edge portion (particularly, the portion along the inter-electrode region 35) of the electrode contact portion 36b. However, the average height position refers to a position obtained by averaging the height positions of irregularities of the electrode contact portion 36a or 36b when the irregularities exist in the electrode contact portion 36a or 36b.

As illustrated in FIG. 4, the covering portion 32a (similarly for the covering portion 32b) partially covers the outer edge portion (the portion along the inter-electrode region 35) of the terminal electrode 40a. The outer edge portion of the terminal electrode 40a includes an outer periphery of the terminal electrode 40a and a peripheral portion of the outer periphery of the terminal electrode 40a. The peripheral portion of the outer periphery of the terminal electrode 40a is a region between a first position on the outer periphery of the terminal electrode 40a and a second position spaced apart a predetermined length inward from the first position in the X-axis direction or the Y-axis direction (however, in the radial direction when the shape of the terminal electrode 40a is a circular shape, an elliptical shape, or the like). The predetermined length is, for example, a length equivalent to 30% or less of the length of the terminal electrode 40a in the X-axis direction or the Y-axis direction (however, a diameter, a major axis, or a minor axis when the shape of the terminal electrode 40a is a circular shape, an elliptical shape, or the like).

In addition, the covering portion 32a (similarly for the covering portion 32b) partially covers the outer edge portion (the portion along the inter-electrode region 35) of the terminal electrode 40b. The outer edge portion of the terminal electrode 40b includes an outer periphery of the terminal electrode 40b and a peripheral portion of the outer periphery of the terminal electrode 40b. The peripheral portion of the outer periphery of the terminal electrode 40b is a region between a first position on the outer periphery of the terminal electrode 40b and a second position spaced apart a predetermined length inward from the first position in the X-axis direction or the Y-axis direction (however, in the radial direction when the shape of the terminal electrode 40b is a circular shape, an elliptical shape, or the like). The predetermined length is, for example, a length equivalent to 30% or less of the length of the terminal electrode 40b in the X-axis direction or the Y-axis direction (however, a diameter, a major axis, or a minor axis when the shape of the terminal electrode 40b is a circular shape, an elliptical shape, or the like).

The covering portion 32a (similarly for the covering portion 32b) may cover the outer edge portion (the portion along the inter-electrode region 35) of one of the terminal electrodes 40a and 40b.

The covering portions 32a and 32b are formed as follows. For example, when the element body 2 is molded, a part of the exterior material constituting the exterior body 30 wraps around to the inter-electrode region 35 on the outer end surface 22a from outside the side surface 22c of the flange portion 22 inside a mold. The covering portions 32a and 32b are formed by compressing and hardening the exterior material that has wrapped around to the inter-electrode region 35.

In the inter-electrode region 35, an outer edge portion of the covering portion 32a (similarly for the covering portion 32b) extends along the outer periphery (fourth side 41a4) of the terminal electrode 40a and the outer periphery (fourth side 41b4) of the terminal electrode 40b. The covering portion 32a is formed in the inter-electrode region 35 so as to reduce a step between the outer end surface 22a of the flange portion 22 and a surface of the terminal electrode 40a, and a step between the outer end surface 22a of the flange portion 22 and a surface of the terminal electrode 40b. A step between a surface of the covering portion 32a and the surface of the terminal electrode 40a, or a step between the surface of the covering portion 32a and the surface of the terminal electrode 40b is 5 μm or less. The similar configuration is applied to a step between a surface of the covering portion 32b and the surface of the terminal electrode 40a, or a step between the surface of the covering portion 32b and the surface of the terminal electrode 40b.

The covering portion 32a and the covering portion 32b are spaced apart from each other along the Y-axis, and for example, the covering portions 32a and 32b are not formed in a central portion of the inter-electrode region 35 in the Y-axis direction. Namely, the covering portions 32a and 32b are partially formed in the inter-electrode region 35, and a part of the outer end surface 22a is exposed between the covering portion 32a and the covering portion 32b. The covering portions 32a and 32b may be formed, for example, in a region of 10% or more of the inter-electrode region 35, or may be formed in a region of 30% or more of the inter-electrode region 35, or may be formed in a region of 50% or more of the inter-electrode region 35, or may be formed in a region of 70% or more of the inter-electrode region 35. However, the covering portions 32a and 32b may be formed in the entire inter-electrode region 35. In this case, the covering portions 32a and 32b are integrated to form one covering portion.

In addition, one or more covering portions may be formed at any position in the inter-electrode region 35. For example, two or more covering portions that are discontinuous with each other may be discretely disposed on the one side or the other side of the inter-electrode region 35 in the Y-axis direction. In addition, two or more covering portions 32a may project from the outer edge portion of the first surface 30a toward the inter-electrode region 35, and two or more covering portions 32b may project from the outer edge portion of the first surface 30a toward the inter-electrode region 35.

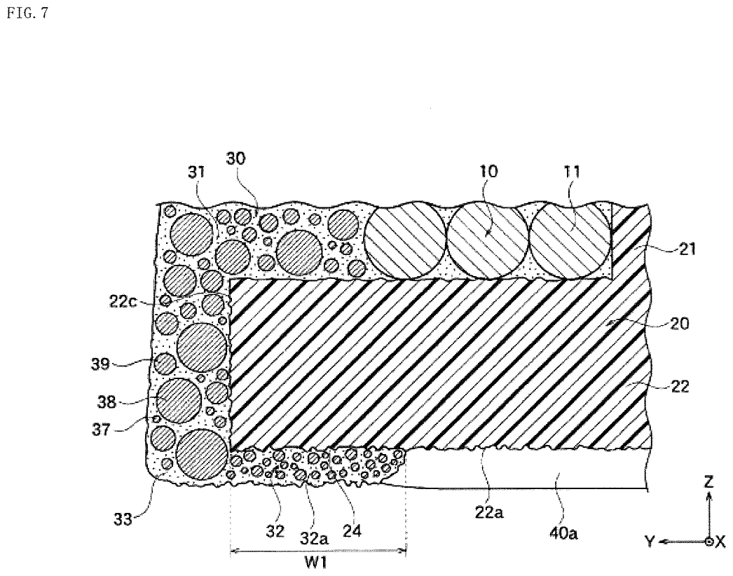

A maximum projection width of the covering portion 32a from the outer edge portion of the first surface 30a is similar to a maximum projection width of the covering portion 32b from the outer edge portion of the first surface 30a, but may be different. A projection width W1 of the covering portion 32a from the side surface 22c of the flange portion 22 (FIG. 7) is not particularly limited, but is less than ½, ⅓ or less, ¼ or less, or ⅕ or less of a width W2 of the flange portion 22 in the Y-axis direction (FIG. 3). The similar configuration is applied to the covering portion 32b. The covering portions 32a and 32b may project from the outer edge portion of the first surface 30a to the central portion of the inter-electrode region 35 in the Y-axis direction. However, the central portion of the inter-electrode region 35 in the Y-axis direction is a region having a width of +Aw in the Y-axis direction with respect to the center of the inter-electrode region 35 in the Y-axis direction. Aw is, for example, a width equivalent to 10% or less of the length of the inter-electrode region 35 in the Y-axis direction. An end portion of the inter-electrode region 35 in the Y-axis direction is a region having a predetermined width in the Y-axis direction (for example, a width equivalent to 20% or less of the length of the inter-electrode region 35 in the Y-axis direction).

As illustrated in FIG. 5, the peripheral edge portion 33 does not overlap the outer end surface 22a of the flange portion 22 when viewed in the axial direction of the core portion 21 (namely, in the Z-axis direction). The peripheral edge portion 33 is continuous with the covering portions 32a to 32c. The peripheral edge portion 33 is raised (protrudes) downward with respect to the electrode contact portion 36a and the electrode contact portion 36b. Particularly, the peripheral edge portion 33 is raised downward with respect to the outer edge portions of the electrode contact portions 36a and 36b (particularly, portions along the first outer edge portion 2b1 to the fourth outer edge portion 2b4 of the first surface 30a illustrated in FIG. 4).

The peripheral edge portion 33 is located lower than the average height position of the electrode contact portions 36a and 36b. Particularly, the peripheral edge portion 33 is located lower than the average height position of the outer edge portions of the electrode contact portions 36a and 36b (particularly, the portions along the first outer edge portion 2b1 to the fourth outer edge portion 2b4 of the first surface 30a).

As illustrated in FIG. 4, the peripheral edge portion 33 is located at the outer edge portion of the first surface 30a. The peripheral edge portion 33 extends along an outer periphery of the outer end surface 22a (FIG. 2) so as to surround the outer end surface 22a when viewed in the Z-axis direction. In the present embodiment, the peripheral edge portion 33 is located at the first outer edge portion 2b1, the second outer edge portion 2b2, the third outer edge portion 2b3, and the fourth outer edge portion 2b4. However, the peripheral edge portion 33 may be located at any one, two, or three of the first outer edge portion 2b1, the second outer edge portion 2b2, the third outer edge portion 2b3, and the fourth outer edge portion 2b4.

The peripheral edge portion 33 is formed in the entire region of the first outer edge portion 2b1 along the X-axis, but may be locally formed in a part of the first outer edge portion 2b1. Similarly, the peripheral edge portion 33 is formed in the entire region of the second outer edge portion 2b2 along the X-axis, but may be locally formed in a part of the second outer edge portion 2b2. In addition, the peripheral edge portion 33 is formed in the entire region of the third outer edge portion 2b3 along the Y-axis, but may be locally formed in a part of the third outer edge portion 2b3. Similarly, the peripheral edge portion 33 is formed in the entire region of the fourth outer edge portion 2b4 along the Y-axis, but may be locally formed in a part of the fourth outer edge portion 2b4.

As illustrated in FIG. 5, the peripheral edge portion 33 is formed by extending a part of the exterior body 30 downward from the height position of the outer end surface 22a (the electrode contact portions 36a and 36b, particularly, the outer edge portions of the electrode contact portions 36a and 36b) at the outer edge portion of the first surface 30a. For example, when the element body 2 is molded, a part of the exterior material constituting the exterior body 30 wraps around to a position lower than the height position of the outer end surface 22 from outside the side surface 22c of the flange portion 22. The peripheral edge portion 33 is formed by compressing and hardening the exterior material that has wrapped around to a position lower than the height position of the outer end surface 22a. A height Ha from the second surface 30b to a lower end of the peripheral edge portion 33 is larger than a height Hb from the second surface 30b to the electrode contact portion 36a or 36b (particularly, the outer edge portion of the electrode contact portion 36a or 36b).

A height (average height or maximum height) Hc1 of the covering portion 32b (similarly for the covering portion 32a) from the electrode contact portion 36a is smaller than the thickness (maximum thickness) T of the terminal electrode 40a. However, the height Hc1 of the covering portion 32b from the electrode contact portion 36a may be equal to the thickness T of the terminal electrode 40a. The thickness (maximum thickness) T of the terminal electrode 40a or 40b is not particularly limited, but is 10 μm or more. The similar configuration is applied to the height of the covering portion 32b from the electrode contact portion 36b.

A height (average height or maximum height) Hc2 of the peripheral edge portion 33 from the electrode contact portion 36a is smaller than the thickness (maximum thickness) T of the terminal electrode 40a. However, the height Hc2 of the peripheral edge portion 33 from the electrode contact portion 36a may be equal to the thickness T of the terminal electrode 40a. The similar configuration is applied to the height of the peripheral edge portion 33 from the electrode contact portion 36b.

The height (average height or maximum height) of the covering portion 32b (similarly for the covering portion 32a) from the electrode contact portion 36a is lower than the height (average height or maximum height) of the peripheral edge portion 33 from the electrode contact portion 36a, but may be equal thereto. The height Hc1 of the covering portion 32b from the electrode contact portion 36a is not particularly limited, but is, for example, ⅔ or less of the thickness (maximum thickness) T of the terminal electrode 40a. The similar configuration is applied to the height of the covering portion 32b from the electrode contact portion 36b.

The height (average height or maximum height) Hc1 of the covering portion 32b (similarly for the covering portion 32a) from the electrode contact portion 36a is larger than the thickness (average thickness or maximum thickness) of the outer edge portion (particularly, the portion along the inter-electrode region 35) of the terminal electrode 40a. However, the height Hc1 of the covering portion 32b from the electrode contact portion 36a may be equivalent to the thickness of the outer edge portion of the terminal electrode 40a. The similar configuration is applied to the height of the covering portion 32b from the electrode contact portion 36b.

In addition, the height (average height or maximum height) Hc2 of the peripheral edge portion 33 from the electrode contact portion 36a is larger than the thickness (average thickness or maximum thickness) of the outer edge portion (particularly, the portions along the first outer edge portion 2b1, the second outer edge portion 2b2, and the third outer edge portion 2b3 of the first surface 30a in FIG. 4) of the terminal electrode 40a. However, the height Hc2 of the peripheral edge portion 33 from the electrode contact portion 36a may be equivalent to the thickness of the outer edge portion of the terminal electrode 40a. The similar configuration is applied to the height of the peripheral edge portion 33 from the electrode contact portion 36b.

The height Hc1 of the covering portions 32a and 32b from the electrode contact portion 36a may not necessarily be constant, and may have a distribution. In addition, the height Hc2 of the peripheral edge portion 33 from the electrode contact portion 36a may not necessarily be constant, and may have a distribution. The surfaces of the covering portions 32a to 32c and the peripheral edge portion 33 do not necessarily need to be flat surfaces, but may be inclined surfaces, convex surfaces, concave surfaces, or uneven surfaces.

As illustrated in FIG. 7, the exterior body 30 includes first magnetic particles (small particles) 37 having a relatively small average particle size; second magnetic particles (large particles) 38 having a relatively large average particle size; and third magnetic particles (medium particles) 39 having an average particle size between the average particle size of the first magnetic particles 37 and the average particle size of the second magnetic particles 38. The inductance value of the coil component 1 can be increased by causing the exterior body 30 to include the second magnetic particles 38 that are large particles. In addition, when the exterior material constituting the exterior body 30 is compression-molded, the first magnetic particles 37 that are small particles and/or the third magnetic particles 39 that are medium particles enter between the second magnetic particles 38 that are large particles, together with the resin, so that the filling density of the magnetic particles in the exterior body 30 is increased, and the magnetic permeability of the exterior body 30 is increased.

In the present embodiment, the first magnetic particles 37, the second magnetic particles 38, and the third magnetic particles 39 are all metal magnetic particles. The first magnetic particles 37, the second magnetic particles 38, and the third magnetic particles 39 may include insulating films covering the metal magnetic particles. The insulating film is not particularly limited; however, examples of the insulating film include metal oxide coatings, resin coatings, and chemical conversion films of phosphorus or zinc, and the like. A thickness of the insulating film is several nm to several tens of nm. The insulation resistance and the withstand voltage can be increased by covering the metallic magnetic particles with insulating films.

The average particle size of the first magnetic particles 37 is not particularly limited, but is, for example, 0.5 μm or more and 10 μm or less. The average particle size of the first magnetic particles 37 is smaller than the thickness of the terminal electrode 40a or 40b. The average particle size of the first magnetic particles 37 may be smaller than the thickness of the covering portion 32 (covering portion 32a, 32b, or 32c).

The average particle size of the second magnetic particles 38 is not particularly limited, but is, for example, larger than 20 μm and equal to or less than 100 μm. The average particle size of the second magnetic particles 38 is equivalent to or larger than the thickness of the terminal electrode 40a or 40b. The average particle size of the second magnetic particles 38 may be equivalent to or larger than the thickness of the covering portion 32 (covering portion 32a, 32b, or 32c).

The average particle size of the third magnetic particles 39 is, for example, larger than 10 μm and equal to or less than 20 μm, or larger than 10 μm and equal to or less than 30 μm. The average particle size of the third magnetic particles 39 is smaller than the thickness of the terminal electrode 40a or 40b, but may be equivalent to or larger than the thickness of the terminal electrode 40a or 40b. In addition, the average particle size of the third magnetic particles 39 may be smaller than the thickness of the covering portion 32 (covering portion 32a, 32b, or 32c), or may be equivalent to or larger than the thickness of the covering portion 32.

The first magnetic particles 37 may have an average particle size that can enter voids 24 of the core 20 (outer end surface 22a). In addition, the third magnetic particles 39 may have an average particle size that can enter the voids 24 of the core 20. The core 20 may have the voids 24 having a minimum diameter (the minimum length of a straight line connecting two points on the outer edge of the void 24 in a cross-section of the void 24) larger than the average particle size of the first magnetic particles 37 or the third magnetic particles 39. The minimum diameter of the voids 24 is not particularly limited, but is, for example, larger than 10 μm. The resin may enter the voids 24 together with the first magnetic particles 37 and/or the third magnetic particles 39.

As a method for calculating the average particle size of the magnetic particles (the first magnetic particles 37, the second magnetic particles 38, or the third magnetic particles 39), a method in which the maximum diameters (the longest length of a straight line connecting two points on the outer edge of each magnetic particle in a cross-section of each magnetic particle) of a plurality of the magnetic particles are measured as particle sizes in an SEM or STEM image of a cross-section of the exterior body 30 and the arithmetic average value (number average value) of the particle sizes is obtained as an average particle size can be used. However, a method in which a particle size distribution is obtained by performing image analysis on an SEM or STEM image of a cross-section of the exterior body 30 and a particle size at which the integrated value thereof becomes 50% (D50, median diameter) is taken as an average particle size may be used.

In the present embodiment, in a YZ cross-section of the exterior body 30, the area ratio of the magnetic particles having a small average particle size is higher in the covering portion 32 (covering portions 32a, 32b, and/or 32c) than in the body portion 31. Particularly, the area ratio of the magnetic particles having an average particle size smaller than the thickness of the terminal electrode 40a or 40b is higher in the covering portion 32 than in the body portion 31. In addition, the area ratio of the magnetic particles having an average particle size smaller than the thickness (average thickness or minimum thickness) of the covering portion 32 (covering portion 32a, 32b, or 32c) is higher in the covering portion 32 than in the body portion 31.

For example, the area ratio of the first magnetic particles 37 is higher in the covering portion 32 than in the body portion 31. The total area ratio of the first magnetic particles 37 and the third magnetic particles 39 (here, particles having an average particle size smaller than the thickness of the terminal electrode 40a or 40b) may be higher in the covering portion 32 than in the body portion 31.

The area ratio of the first magnetic particles 37 in the covering portion 32 is not particularly limited, but is, for example, 50% or more, 60% or more, or 70% or more. Meanwhile, the area ratio of the second magnetic particles 38 in the covering portion 32 is not particularly limited, but is, for example, 10% or less, or 5% or less. The total area ratio of the first magnetic particles 37 and the third magnetic particles 39 in the covering portion 32 is not particularly limited, but may be, for example, 50% or more, 60% or more, 70% or more, or 80% or more.

In the covering portion 32, the area ratio of the first magnetic particles 37 is the highest, and the area ratio of the second magnetic particles 38 is the lowest. In the example illustrated in FIG. 7, the area ratio of the second magnetic particles 38 in the covering portion 32 (covering portions 32a, 32b, and/or 32c) is substantially 0%. In the covering portion 32, the area ratio of the third magnetic particles 39 may be lower than the area ratio of the first magnetic particles 37 and higher than the area ratio of the second magnetic particles 38.

The area ratio of the magnetic particles (the first magnetic particles 37, the second magnetic particles 38, or the third magnetic particles 39) can be measured by observing a cross-section of the exterior body 30 using a scanning electron microscope (SEM) or a scanning transmission electron microscope (STEM), binarizing the obtained cross-sectional image, and performing image analysis on the area ratio occupied by the magnetic particles with respect to the entire image of a predetermined area (for example, unit area).

In the present embodiment, in a YZ cross-section of the exterior body 30, the area ratio of the magnetic particles having a small average particle size is higher in the covering portion 32 (covering portions 32a, 32b, and/or 32c) than in the peripheral edge portion 33. Particularly, the area ratio of the magnetic particles having an average particle size smaller than the thickness of the terminal electrode 40a or 40b is higher in the covering portion 32 than in the peripheral edge portion 33. In addition, the area ratio of the magnetic particles having an average particle size smaller than the thickness of the covering portion 32 (covering portion 32a, 32b, or 32c) is higher in the covering portion 32 than in the peripheral edge portion 33.

For example, the area ratio of the first magnetic particles 37 is higher in the covering portion 32 than in the peripheral edge portion 33. The total area ratio of the first magnetic particles 37 and the third magnetic particles 39 (here, particles having an average particle size smaller than the thickness of the terminal electrode 40a or 40b) may be higher in the covering portion 32 than in the peripheral edge portion 33.

Next, a method for manufacturing the coil component 1 will be described. First, the core 20 illustrated in FIG. 3 is prepared. Next, the terminal electrodes 40a and 40b are formed on the flange portion 22 by a paste method, a plating method, sputtering, screen printing, or the like. Next, the winding portion 11 is fitted into the core portion 21. Alternatively, the wire 10 is wound around the core portion 21. Next, the lead-out portion 12a is connected to the terminal electrode 40a, and the lead-out portion 12b is connected to the terminal electrode 40b.

Next, a release sheet is disposed in a mold (not illustrated), and the core 20 illustrated in FIG. 3 is installed in the mold such that the surfaces of the terminal electrodes 40a and 40b come into contact with the release sheet. Next, the inside of the mold is filled with the exterior material (the first magnetic particles 37, the second magnetic particles 38, and the third magnetic particles 39) constituting the exterior body 30. Accordingly, the core portion 21, the winding portion 11, and the flange portion 22 are covered with the exterior material. In addition, the exterior material enters a space between the release sheet and the outer end surface 22a of the flange portion 22. Accordingly, the outer edge portions of the terminal electrodes 40a and 40b are covered with the exterior material. In addition, the exterior material enters the inter-electrode region 35 (FIG. 4), and the inter-electrode region 35 is partially covered with the exterior material.

Next, the exterior material is compressed and hardened at a predetermined temperature for a predetermined time. Accordingly, the element body 2 (FIG. 1) is formed. In detail, the exterior material covering the core portion 21, the winding portion 11, and the flange portion 22 becomes the body portion 31 illustrated in FIGS. 5 and 6. In addition, the exterior material covering the outer edge portions of the terminal electrodes 40a and 40b becomes the covering portion 32c (32) illustrated in FIG. 5. In addition, the exterior material covering the inter-electrode region 35 becomes the covering portions 32a and 32b (32) illustrated in FIG. 6. In addition, the peripheral edge portion 33 illustrated in FIG. 4 is formed at the outer edge portion (the first outer edge portion 2b1, the second outer edge portion 2b2, the third outer edge portion 2b3, and the fourth outer edge portion 2b4) of the first surface 30a.

The size, shape, formation range, and the like of the covering portions 32a to 32c illustrated in FIG. 4 can be adjusted depending on conditions such as the amount of the exterior material that wraps around to the inter-electrode region 35, the pressure when the exterior material is compressed, the types of magnetic particles and resin constituting the exterior material, the size of the mold, and the disposition of the core 20 in the mold.

As illustrated in FIG. 7, since the second magnetic particles 38 have a relatively large particle size, the second magnetic particles 38 cannot enter the space between the release sheet and the outer end surface 22a of the flange portion 22. Meanwhile, since the first magnetic particles 37 and/or the third magnetic particles 39 have a relatively small particle size, the first magnetic particles 37 and the third magnetic particles 39 can enter the space between the release sheet and the outer end surface 22a of the flange portion 22. Therefore, in a cross-section of the exterior body 30, the area ratio of the magnetic particles having a small average particle size is higher in the covering portion 32 (covering portions 32a, 32b, and/or 32c) than in the body portion 31. The coil component 1 can be obtained in such a manner.

As illustrated in FIGS. 5 and 6, in the coil component 1 of the present embodiment, the exterior body 30 includes the body portion 31 covering at least the core portion 21 and the winding portion 11, and the covering portion 32 raised with respect to the outer end surface 22a of the flange portion 22, and overlapping the outer end surface 22a when viewed in the axial direction of the core portion 21. Since the covering portion 32 covers the outer end surface 22a of the flange portion 22, the covering portion 32 serves as a stopper (retainer) that fixes the core 20 to the body portion 31. Accordingly, the fixing strength (connection strength) between the core 20 and the exterior body 30 is increased, so that the core 20 is less likely to peel off from the exterior body 30.

In addition, as illustrated in FIG. 7, in the coil component 1 of the present embodiment, in a cross-section of the exterior body 30, the area ratio of the magnetic particles having a small average particle size is higher in the covering portion 32 (for example, the covering portion 32a) than in the body portion 31. Therefore, the magnetic particles of the covering portion 32 easily enter irregularities formed on the outer end surface 22a of the flange portion 22, and the covering portion 32 is fixed (connected) to the flange portion 22 via the magnetic particles that have entered the irregularities. Accordingly, the fixing strength (connection strength) between the flange portion 22 and the covering portion 32 is increased, so that the core 20 is even less likely to peel off from the exterior body 30.

In addition, the exterior body 30 includes the peripheral edge portion 33 raised with respect to the outer end surface 22a of the flange portion 22, and not overlapping the outer end surface 22a when viewed in the axial direction of the core portion 21. Furthermore, in a cross-section of the exterior body 30, the area ratio of the magnetic particles having a small average particle size is higher in the covering portion 32 than in the peripheral edge portion 33. In this case, the area ratio of the magnetic particles having a large average particle size is also higher in the peripheral edge portion 33 as well as the body portion 31 than in the covering portion 32. Accordingly, in the exterior body 30, the area ratio of the magnetic particles having a relatively large average particle size is increased, and the inductance characteristics of the coil component 1 are improved.

In addition, the core 20 is a sintered core having the voids 24. Therefore, in the covering portion 32, the magnetic particles enter the voids 24 (irregularities) of the outer end surface 22a, and the covering portion 32 and the flange portion 22 are fixed (connected) to each other via the magnetic particles that have entered the voids 24. Accordingly, the fixing strength (connection strength) between the flange portion 22 and the covering portion 32 can be further increased.

In addition, the covering portion 32 includes the magnetic particles having an average particle size that can enter the voids 24. Therefore, the magnetic particles easily enter the voids 24 of the outer end surface 22a, so that the fixing strength (connection strength) between the flange portion 22 and the covering portion 32 can be further increased.

In addition, the surface roughness of the outer end surface 22a is smaller than the surface roughness of the covering portion 32. Therefore, solder, a conductive adhesive, or the like is less likely to adhere to the surface of the covering portion 32. Accordingly, the solder, conductive adhesive, or the like can be prevented from protruding from the terminal electrode 40a by the covering portion 32.

In addition, as illustrated in FIG. 4, the covering portion 32 is located at least in the inter-electrode region 35 between the terminal electrode 40a and the terminal electrode 40b. By forming the covering portion 32 in the inter-electrode region 35, the covering portion 32 and the flange portion 22 are fixed (connected) to each other at a central portion of the outer end surface 22a of the flange portion 22 (here, the central portion in the X-axis direction connecting the terminal electrode 40a and the terminal electrode 40b). Accordingly, the fixing strength (connection strength) between the flange portion 22 and the covering portion 32 can be further increased.

### Second Embodiment

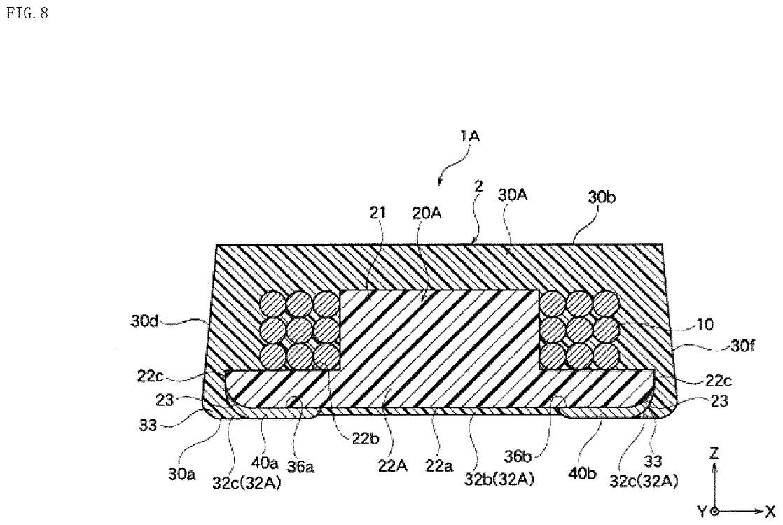

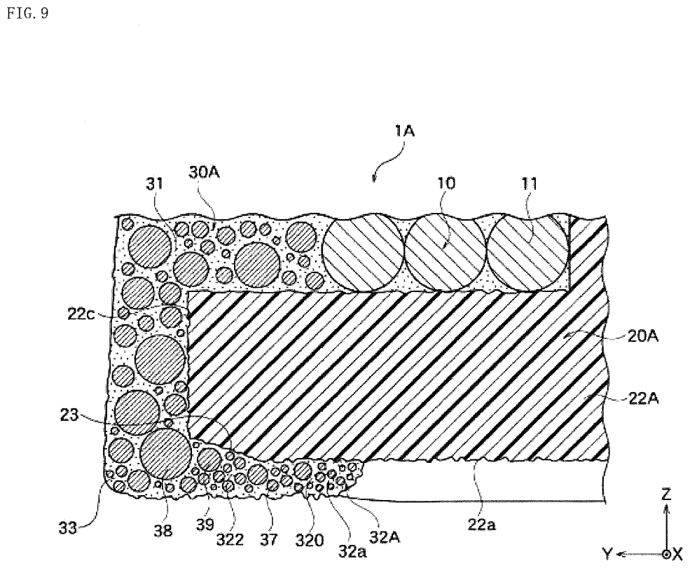

A coil component 1A of a second embodiment illustrated in FIGS. 8 and 9 has a configuration similar to that of the coil component 1 of the first embodiment, except for the following points. Portions that overlap with the coil component 1 of the first embodiment are denoted by the same reference numerals, and detailed descriptions thereof will be omitted.

As illustrated in FIG. 9, the coil component 1A includes a core 20A and an exterior body 30A. The core 20A includes a flange portion 22A. The flange portion 22A includes a chamfered portion 23. The chamfered portion 23 is formed at a ridge portion located between the outer end surface 22a and the side surface 22c. At the position of the chamfered portion 23, the outer end surface 22a is inclined with respect to the inner end surface 22b, and a thickness of the flange portion 22A becomes thinner toward the outer periphery of the outer end surface 22a. When the flange portion 22A is provided with the chamfered portion 23, a part of an exterior material constituting the exterior body 30A easily wraps around to a position lower than the height position of the outer end surface 22a from outside the side surface 22c of the flange portion 22A, and more easily wraps around onto the terminal electrode 40a. Therefore, the covering portion 32c (FIG. 8) can indirectly cover at least a part of the chamfered portion 23 while covering the outer edge portion of the terminal electrode 40a. In the example illustrated in FIG. 8, the surface of the terminal electrode 40a is flat except for both end portions of the terminal electrode 40a in the X-axis direction. However, the shape of the terminal electrode 40a may be similar to the shape of the terminal electrode 40a illustrated in FIG. 5. The similar configuration is applied to the terminal electrode 40b.

A depth (maximum value) of the chamfered portion 23 from the outer end surface 22a of the flange portion 22A is not particularly limited, but is, for example, 10 μm or more and 50 μm or less. The depth of the chamfered portion 23 may be equivalent to or less than the thickness of the terminal electrode 40a or 40b, or may be equivalent to or larger than the thickness of the terminal electrode 40a or 40b.

The exterior body 30A includes a covering portion 32A. The covering portion 32A (covering portions 32a, 32b, and/or 32c) has a small particle size region 320 and a large particle size region 322. The small particle size region 320 does not overlap the chamfered portion 23 when viewed in the Z-axis direction (in the Z-axis direction). Meanwhile, the large particle size region 322 overlaps the chamfered portion 23 when viewed in the Z-axis direction (in the Z-axis direction). The small particle size region 320 is located closer to the inside of the outer end surface 22a than the large particle size region 322 in the radial direction of the flange portion 22A (the Y-axis direction in the example illustrated in FIG. 9).

In a YZ cross-section of the exterior body 30A, the area ratio of the magnetic particles having a large average particle size is higher in the large particle size region 322 than in the small particle size region 320. For example, the area ratio of the third magnetic particles 39 (particles having an average particle size smaller than the thickness of the terminal electrode 40a or 40b) in the large particle size region 322 than in the small particle size region 320. The total area ratio of the first magnetic particles 37 and the third magnetic particles 39 may be higher in the large particle size region 322 than in the small particle size region 320.

In a YZ cross-section of the exterior body 30A, the area ratio of the magnetic particles having a small average particle size is higher in the small particle size region 320 and/or the large particle size region 322 than in the body portion 31. Particularly, the area ratio of the magnetic particles having an average particle size smaller than the thickness of the terminal electrode 40a or 40b is higher in the small particle size region 320 and/or the large particle size region 322 than in the body portion 31. In addition, the area ratio of the magnetic particles having an average particle size smaller than the thickness of the covering portion 32 (covering portion 32a, 32b, or 32c) is higher in the small particle size region 320 and/or the large particle size region 322 than in the body portion 31.

For example, the area ratio of the first magnetic particles 37 is higher in the small particle size region 320 and/or the large particle size region 322 than in the body portion 31. The total area ratio of the first magnetic particles 37 and the third magnetic particles 39 (here, particles having an average particle size smaller than the thickness of the terminal electrode 40a or 40b) may be higher in the small particle size region 320 and/or the large particle size region 322 than in the body portion 31.

In a YZ cross-section of the exterior body 30A, the area ratio of the magnetic particles having a small average particle size is higher in the small particle size region 320 and/or the large particle size region 322 than in the peripheral edge portion 33. Particularly, the area ratio of the magnetic particles having an average particle size smaller than the thickness of the terminal electrode 40a or 40b is higher in the small particle size region 320 and/or the large particle size region 322 than in the peripheral edge portion 33. In addition, the area ratio of the magnetic particles having an average particle size smaller than the thickness of the covering portion 32 (covering portion 32a, 32b, or 32c) is higher in the small particle size region 320 and/or the large particle size region 322 than in the peripheral edge portion 33.

For example, the area ratio of the first magnetic particles 37 is higher in the small particle size region 320 and/or the large particle size region 322 than in the peripheral edge portion 33. The total area ratio of the first magnetic particles 37 and the third magnetic particles 39 (here, particles having an average particle size smaller than the thickness of the terminal electrode 40a or 40b) may be higher in the small particle size region 320 and/or the large particle size region 322 than in the peripheral edge portion 33.

In the present embodiment as well, effects similar to those of the first embodiment can be obtained. In addition, in the present embodiment, as illustrated in FIG. 9, the flange portion 22A includes the chamfered portion 23 formed at the ridge portion between the outer end surface 22a and the side surface 22c. Therefore, in the manufacturing process of the coil component 1A, magnetic particles having a relatively small average particle size easily flow toward the outer end surface 22a of the flange portion 22A through the chamfered portion 23. Accordingly, the covering portion 32A is easily formed to overlap the outer end surface 22a of the flange portion 22A when viewed in the axial direction (Z-axis direction) of the core portion 21.

In addition, the covering portion 32A includes the small particle size region 320 and the large particle size region 322. The small particle size region 320 does not overlap the chamfered portion 23 when viewed in the axial direction of the core portion 21. The large particle size region 322 overlaps the chamfered portion 23 when viewed in the axial direction of the core portion 21. Furthermore, the area ratio of the magnetic particles having a large average particle size is higher in the large particle size region 322 than in the small particle size region 320. Therefore, the area ratio of the magnetic particles having a large average particle size is higher in the large particle size region 322 as well as the body portion 31 than in the small particle size region 320. Accordingly, in the exterior body 30A, the area ratio of the magnetic particles having a relatively large average particle size is increased, and the inductance characteristics of the coil component 1A are improved.

In addition, in the manufacturing process of the coil component 1A (compression molding process of magnetic particles and resin), when magnetic particles having a relatively large average particle size are disposed at a position overlapping the chamfered portion 23 (a position corresponding to the large particle size region 322), the following effects can be obtained. Namely, magnetic particles having a relatively small average particle size flow toward a position overlapping the outer end surface 22a of the flange portion 22A (a position corresponding to the small particle size region 320) in a manner to slip through gaps between the magnetic particles having a relatively large average particle size. Accordingly, the magnetic particles having a relatively small average particle size are selectively disposed at the position overlapping the outer end surface 22a of the flange portion 22A. Therefore, the small particle size region 320 is easily formed at the position overlapping the outer end surface 22a.

In addition, the small particle size region 320 is located closer to the inside of the outer end surface 22a than the large particle size region 322 in the radial direction of the flange portion 22A. Therefore, on the inside of the outer end surface 22a, the covering portion 32A and the flange portion 22A are fixed (connected) to each other via the magnetic particles that have entered irregularities. Accordingly, the fixing strength (connection strength) between the flange portion 22A and the covering portion 32A can be further increased.

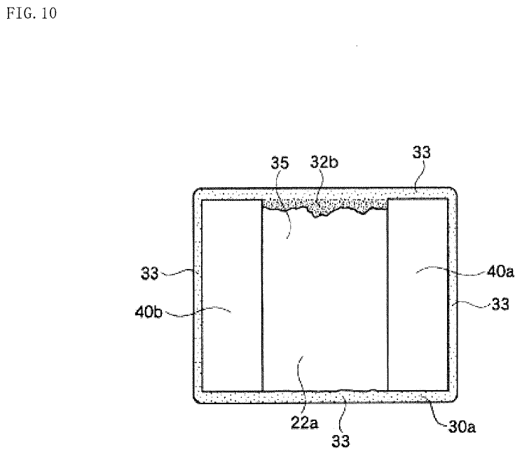

The present disclosure is not limited to the above-described embodiments, and various modifications can be made without departing from the scope of the present disclosure. For example, as illustrated in FIG. 10, in each of the above-described embodiments, only the covering portion 32b may be formed in the inter-electrode region 35. Although detailed illustration is omitted, only the covering portion 32a may be formed in the inter-electrode region 35.

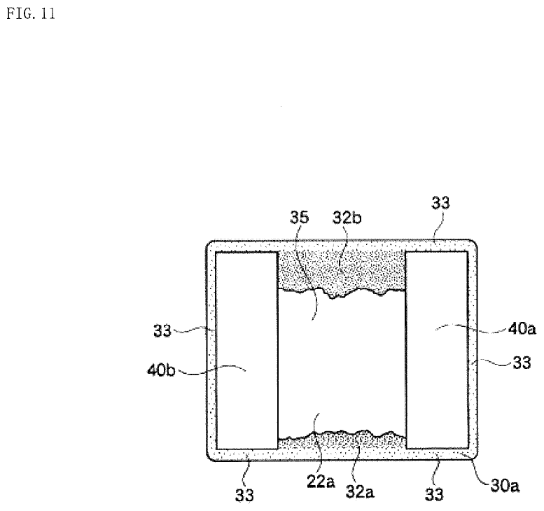

In addition, as illustrated in FIG. 11, in each of the above-described embodiments, the area of the covering portion 32b may be larger than the area of the covering portion 32a. Although detailed illustration is omitted, the area of the covering portion 32a may be larger than the area of the covering portion 32b.

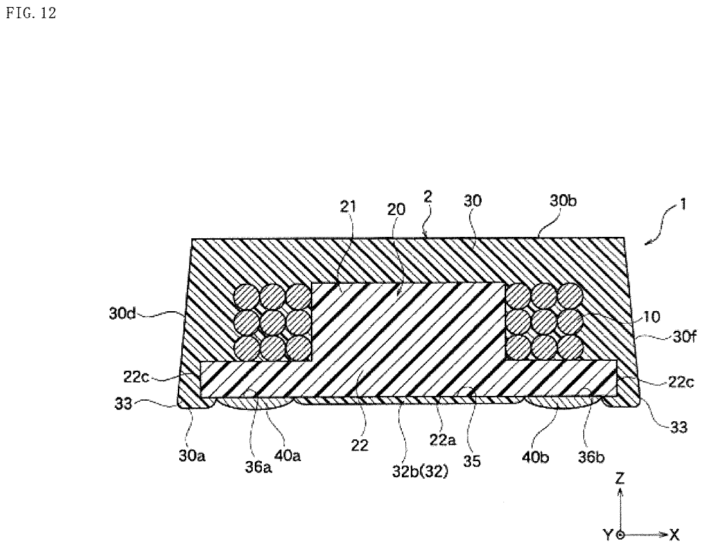

In addition, as illustrated in FIG. 12, in each of the above-described embodiments, the covering portion 32 may not cover the terminal electrodes 40a and 40b. In the example illustrated in FIG. 10, the covering portion 32 is adjacent to the terminal electrodes 40a and 40b without overlapping the terminal electrodes 40a and 40b. The covering portion 32 is in contact with the terminal electrodes 40a and 40b along the X-axis direction, but may be spaced apart from the terminal electrodes 40a and 40b.

In addition, the peripheral edge portion 33 may directly cover at least a part of the outer edge portion of the outer end surface 22a. In the example illustrated in FIG. 12, a part of the peripheral edge portion 33 is located on the outer edge portion of the outer end surface 22a, and overlaps the outer end surface 22a.

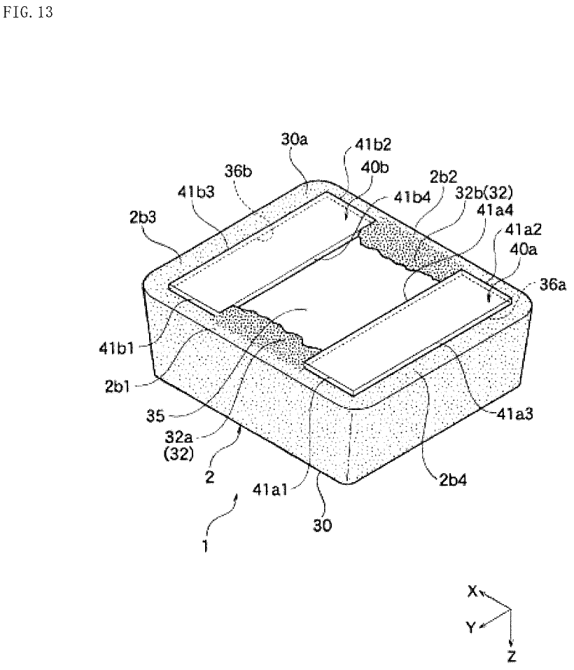

In addition, as illustrated in FIG. 13, in each of the above-described embodiments, the covering portion 32 may not be provided with the covering portion 32c and the peripheral edge portion 33. In the example illustrated in FIG. 13, the covering portions 32a and 32b are formed in the inter-electrode region 35 without being exposed to the outside of the inter-electrode region 35.

In each of the above-described embodiments, as illustrated in FIG. 7, the exterior body 30 contains magnetic particles having three types of average particle sizes (the first magnetic particles 37, the second magnetic particles 38, and the third magnetic particles 39), but may contain magnetic particles having two types of average particle sizes, or may contain magnetic particles having four or more types of average particle sizes.

In each of the above-described embodiments, as illustrated in FIG. 3, the core 20 is a T-core, but may be a drum core in which the flange portions 22 are formed at both ends of the core portion 21 in the axial direction.

In each of the above-described embodiments, the winding portion 11 illustrated in FIG. 3 may be made of a flat wire that is wound edgewise or flatwise.

In each of the above-described embodiments, the winding axis direction of the winding portion 11 illustrated in FIG. 3 may be parallel to the first surface 30a.

In each of the above-described embodiments, the embedded portions 44 and 46 may be omitted from the terminal electrode 40a illustrated in FIG. 3. The similar configuration is applied to the terminal electrode 40b.

In each of the above-described embodiments, the core 20 illustrated in FIG. 3 may not be a sintered body, and may be formed from a material and by a manufacturing method similar to those of the exterior body 30.

### REFERENCE NUMERALS

1, 1A COIL COMPONENT
2 ELEMENT BODY
2b1 to 2b4 FIRST OUTER EDGE PORTION TO FOURTH OUTER EDGE PORTION
10 WIRE
11 WINDING PORTION
12a, 12b LEAD-OUT PORTION
20, 20A CORE
21 CORE PORTION
22, 22A FLANGE PORTION
22a OUTER END SURFACE
22b INNER END SURFACE
22c SIDE SURFACE
23 CHAMFERED PORTION
24 VOID
30, 30A EXTERIOR BODY
30a to 30f FIRST SURFACE TO SIXTH SURFACE
31 BODY PORTION
32, 32A, 32a, 32b, 32c COVERING PORTION
320 SMALL PARTICLE SIZE REGION
322 LARGE PARTICLE SIZE REGION
33 PERIPHERAL EDGE PORTION
35 INTER-ELECTRODE REGION
36a, 36b ELECTRODE CONTACT PORTION
37 FIRST MAGNETIC PARTICLE
38 SECOND MAGNETIC PARTICLE
39 THIRD MAGNETIC PARTICLE
40a, 40b TERMINAL ELECTRODE
41a1, 41a2, 41a3, 41a4, 41b1, 41b2, 41b3, 41b4 FIRST SIDE TO FOURTH SIDE
42 EXPOSED PORTION
44, 46 EMBEDDED PORTION

What is claimed is:

1. A coil component, comprising:
a core including a core portion and a flange portion formed at one end of the core portion in an axial direction;
a wire including a winding portion provided on the core portion; and
an exterior body containing magnetic particles having different average particle sizes and a resin,
wherein the exterior body includes a body portion covering at least the core portion and the winding portion, and a covering portion raised with respect to an outer end surface of the flange portion, and overlapping the outer end surface when viewed in the axial direction, and
in a cross-section of the exterior body, an area ratio of the magnetic particles having a small average particle size is higher in the covering portion than in the body portion.

2. The coil component according to claim 1,
wherein the exterior body includes a peripheral edge portion raised with respect to the outer end surface of the flange portion, and not overlapping the outer end surface when viewed in the axial direction, and
in a cross-section of the exterior body, an area ratio of the magnetic particles having a small average particle size is higher in the covering portion than in the peripheral edge portion.

3. The coil component according to claim 1,
wherein the flange portion includes an inner end surface facing the outer end surface along the axial direction, a side surface connecting the inner end surface and the outer end surface, and a chamfered portion formed at a ridge portion between the outer end surface and the side surface.

4. The coil component according to claim 3,
wherein the covering portion has a small particle size region and a large particle size region,
the small particle size region does not overlap the chamfered portion when viewed in the axial direction,
the large particle size region overlaps the chamfered portion when viewed in the axial direction, and
an area ratio of the magnetic particles having a large average particle size is higher in the large particle size region than in the small particle size region.

5. The coil component according to claim 4,
wherein the small particle size region is located closer to an inside of the outer end surface than the large particle size region in a radial direction of the flange portion.

6. The coil component according to claim 1,
wherein the core is a sintered core having voids.

7. The coil component according to claim 6,
wherein the covering portion contains the magnetic particles having an average particle size that can enter the voids.

8. The coil component according to claim 1,
wherein a surface roughness of the outer end surface is smaller than a surface roughness of the covering portion.

9. The coil component according to claim 1, further comprising:
a first terminal electrode and a second terminal electrode provided at least on the outer end surface,
wherein the wire includes a first lead-out portion led out from the winding portion and connected to the first terminal electrode, and a second lead-out portion led out from the winding portion and connected to the second terminal electrode, and
the covering portion is located at least in an inter-electrode region between the first terminal electrode and the second terminal electrode.
